(19) United States
(12) Patent Application Publication
(10) Pub. No.: US 2006/0043654 A1
(43) Pub. Date: Mar. 2, 2006

(54) Energy-managing mounts

(75) Inventor: Daryoush Allaei, Minnetonka, MN (US)

Correspondence Address: Leffert Jay & Polglaze, P.A., P. O. Box 581009, Minneapolis, MN, 55458-1009, US

(73) Assignee: Quality Research Development & Consulting, Inc.

(21) Appl. No.: 10/929,833

(22) Filed: Aug. 30, 2004

(51) Int. Cl. F16M 7/00

(52) U.S. Cl. 267/140.3; 267/293; 267/153

(57) ABSTRACT

Methods and apparatus are provided. A mount adapted to connect a vibration source to a support structure has a first elastomeric layer having a first stiffness, and a second elastomeric layer connected to the first elastomeric layer and having a second stiffness that is greater than the first stiffness.

### TECHNICAL FIELD OF THE INVENTION

The present invention relates generally to mounts and in particular the present invention relates to “energy-managing” mounts for connecting a vibration source to a support structure.

### BACKGROUND OF THE INVENTION

A vibration source, such as an engine, is typically mounted on a support structure, such as a vehicle that is powered by the engine, using mounts. Mounts are typically used to reduce the transmission of vibration energy from the vibration source to the support structure. Another application involves using mounts to mount an engine for generating power for shelters, such as used by the military, to its support structure to reduce the transmission of vibration energy from the engine to the shelter. Examples of common mounts include, but are not limited to, metal and air springs, elastic mounts, and viscoelastic mounts. However, these mounts are often only effective for limited range of operating frequencies. Moreover these mounts are not very effective for applications involving shocks due to vehicle operation or when a vehicle is deployed by parachute for some military applications.

For the reasons stated above, and for other reasons stated below which will become apparent to those skilled in the art upon reading and understanding the present specification, there is a need in the art for alternative mounts for mounting vibration sources to support structures.

### SUMMARY

The above-mentioned problems with mounts and other problems are addressed by the present invention and will be understood by reading and studying the following specification.

The various embodiments relate to mounts (e.g., “energy-managing” mounts) that are self-reconfigurable in that they can reconfigure their phase from soft to hard due to the loading thereon, e.g., using a nonlinear stiffness characteristic, with relatively consistent vibration damping over a broadband of vibration frequencies.

One embodiment of the invention provides a mount adapted to connect a vibration source to a support structure. The mount includes a first elastomeric layer having a first stiffness, and a second elastomeric layer connected to the first elastomeric layer and having a second stiffness that is different than the first stiffness.

Another embodiment of the invention provides a mount adapted to connect a vibration source to a support structure. The mount includes a bracket, a first elastomeric layer having a first stiffness overlying a portion of the bracket, a second elastomeric layer overlying the first elastomeric layer and having a second stiffness that is different than the first stiffness, a third elastomeric layer having the first stiffness and underlying the portion of the bracket so that the portion of the bracket is sandwiched between the first and third layers.

Another embodiment of the invention provides a method of operation of a mount adapted to connect a vibration source to a support structure. The method includes dissipating vibration energy from the vibration source using a first layer of the mount, and absorbing shock load energy using a second layer of the mount that is connected in series with the first layer.

Another embodiment of the invention provides a method of connecting a vibration source to a support structure. The method includes disposing first and second elastomeric layers between the vibration source and support structure so that the second layer is located between the first layer and the vibration source, wherein the first and second layers have different stiffnesses.

Further embodiments of the invention include methods and apparatus of varying scope.

### BRIEF DESCRIPTION OF THE DRAWINGS

FIG. 1 illustrates a mount, according to an embodiment of the invention.

FIG. 2 is a cross-sectional view of a mount in operation, according to another embodiment of the invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

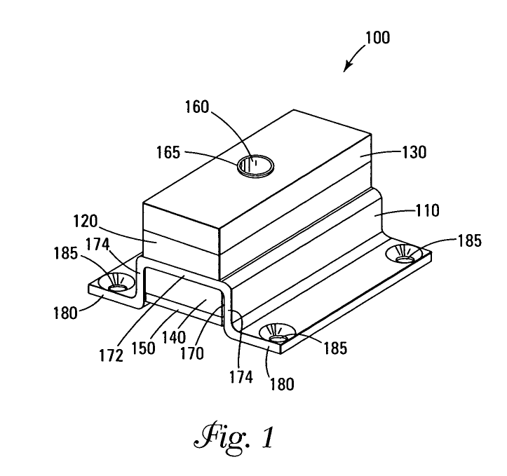

FIG. 1 illustrates a mount 100, such as an engine mount, according to an embodiment of the invention. Mount 100 includes a bracket 110, e.g., of steel. A first layer 120 of elastomeric material, e.g., neoprene, having a first stiffness overlies bracket 110. A second layer 130 of elastomeric material, such as polyurethane, having a second stiffness overlies the first layer 120 and is connected in series therewith. A suitable polyurethane for the second layer 130 is a microcellular polyurethane, such as Navcell HP manufactured by Navtech, L.L.C., Northville, Mich., USA.

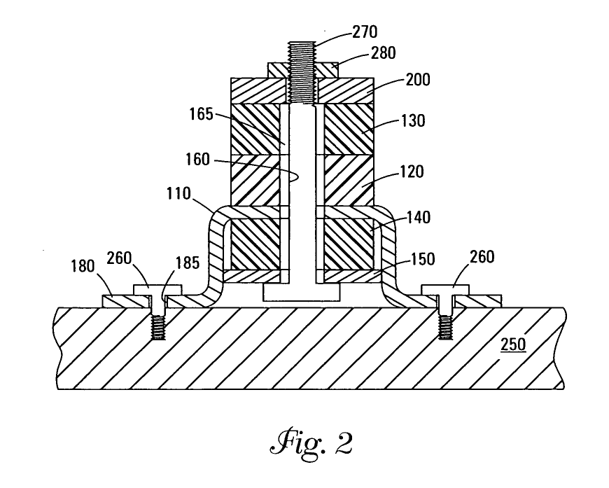

For one embodiment, a third layer 140 of elastomeric material, e.g., neoprene, having the first stiffness underlies bracket 110 so that a portion of bracket 110 is sandwiched between the third layer 140 and the first layer 120, as shown in FIG. 1. A retaining plate 150, e.g., of metal, such as steel, underlies the third layer 140 for another embodiment so that the third layer 140 is sandwiched between plate 150 and bracket 110. For another embodiment, a hole 160 passes through the second layer 130, first layer 120, bracket 110, third layer 140, and plate 150. For another embodiment, a sleeve 165 is disposed in hole 160 (FIGS. 1 and 2). For one embodiment, sleeve 165 may be a tubular rivet that holds the second layer 130, the first layer 120, bracket 110, the third layer 140, and plate 150 together.

For one embodiment, the second stiffness of the elastomeric material of the second layer 130 is nominally greater that the first stiffness of the elastomeric material of the first layer 120 or the first layer 120 and the third layer 140. For another embodiment, the second stiffness of the elastomeric material of the second layer 130 increases with increasing load on the second layer 130, e.g., in a nonlinear fashion.

For one embodiment, bracket 110 has a U-shaped portion 170 that contains the third layer 140 and plate 150, as shown in FIG. 1. For another embodiment, each side of U-shaped portion 170 is connected to a flange 180 having holes 185 passing therethrough. Specifically, U-shaped portion 170 includes a cross member 172 connected between depending legs 174, with legs 174 respectively connected to flanges 180. Note that the first layer 120 is disposed on cross member 172 and that the first layer 120 and the third layer 140 sandwich cross member 172 therebetween. In this embodiment, hole 160 passes through cross member 172.

FIG. 2 is a cross-sectional view of mount 100 in operation, according to another embodiment of the invention. In particular, FIG. 2 shows mount 100 connecting a portion of a vibration source 200, such as an engine, to a support structure 250, such as a chassis of a vehicle. For one embodiment, fasteners 260, such as cap screws, pass through holes 185 of bracket 110 and thread into support structure 250 for securing mount 100 to support structure 250. For another embodiment, a bolt 270 passes through the hole 160 of mount 100 and through a hole in the portion vibration source 200. A nut 280 is threaded on an end of bolt 270 to secure the portion of vibration source 200 to the second layer 130 of mount 100.

During operation, the sandwiching of cross member 172 of bracket 110 between the first layer 120 and the third layer 140 acts to reduce vibration that is transmitted to structure 250 from vibration source 200. This acts to reduce the structural borne sound (noise) inside a vehicle that includes structure 250 or an adjacent shelter or structure connected to structure 250. Note that third layer 140 may be eliminated for some embodiments. For these embodiments, the first layer 120 acts to reduce vibration that is transmitted to structure 250 from vibration source 200. The second layer 130 acts absorb energy flow associated with shock (or impact) loading generated, e.g., during the vehicle operation or when the vehicle is deployed, e.g., by parachute for military applications.

Therefore, mount 100 acts to dissipate lower load vibratory energy, and thus noise, and to absorb the higher shock-load energy flow between vibration source 200 and support structure 250 substantially simultaneously. This means that mount 100 is self-reconfigurable in that it can reconfigure its phase from soft to hard due to the loading thereon, e.g., using the nonlinear stiffness characteristic of the second layer 130, with relatively consistent vibration damping over a broadband of vibration frequencies. That is, the first layer 120 or the first layer 120 and the third layer 140 act as vibration and noise reducing layers and the second layer 130 acts as a shock load absorbing layer. For other embodiments, the second layer 130 also acts to support the weight of vibration source 200.

It will be appreciated that for some embodiments, the first layer 120 and the second layer 130 may be interchanged, with the second layer 130 overlying cross member 174 of bracket 110 and the first layer 120 overlying the second layer 130 and that further vibration damping and/or shock absorbing layers could be added.

### CONCLUSION

The various embodiments relate to mounts, e.g. (“energy-managing” mounts) that are self-reconfigurable in that they can reconfigure their phase from soft to hard due to the loading thereon, e.g., using a nonlinear stiffness characteristic, with relatively consistent vibration damping over broadband of vibration frequencies. For one embodiment, a mount that is adapted to connect a vibration source to a support structure has a first elastomeric layer having a first stiffness, and a second elastomeric layer connected to the first elastomeric layer and having a second stiffness that is greater than the first stiffness.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A mount adapted to connect a vibration source to a support structure, comprising:
a first elastomeric layer having a first stiffness; and
a second elastomeric layer in contact with the first elastomeric layer along a single continuous plane and having a second stiffness that is different than the first stiffness.

2. The mount of claim 1, wherein the second stiffness is greater than the first stiffness.

3. The mount of claim 2, wherein the second elastomeric layer overlies the first elastomeric layer.

4. The mount of claim 3, and further comprising a bracket connected to the first elastomeric layer.

5. The mount of claim 4, wherein the bracket comprises a U-shaped portion connected to a pair of flanges.

6. The mount of claim 4, and further comprising a third elastomeric layer, wherein a portion of the bracket is sandwiched between the first and third elastomeric layers.

7. The mount of claim 2, wherein the first elastomeric layer overlies the second elastomeric layer.

8. The mount of claim 7, and further comprising a bracket connected to the second elastomeric layer.

9. The mount of claim 8, and further comprising a third elastomeric layer, wherein a portion of the bracket is sandwiched between the second and third elastomeric layers.

10. The mount of claim 1, wherein the first elastomeric layer is of neoprene and the second elastomeric layer is of polyurethane.

11. (canceled)

12. A mount adapted to connect a vibration source to a support structure, comprising:
a bracket;
a first elastomeric layer having a first stiffness overlying a portion of the bracket;
a second elastomeric layer overlying the first elastomeric layer and having a second stiffness that is different than the first stiffness, wherein the first and second elastomeric layers are in contact along a single continuous plane; and
a third elastomeric layer having the first stiffness and underlying the portion of the bracket so that the portion of the bracket is sandwiched between the first and third layers.

13. The mount of claim 12, wherein the second stiffness is greater than the first stiffness.

14. The mount of claim 12, wherein the first and third elastomeric layers are of neoprene and the second elastomeric layer is of microcellular polyurethane.

15. The mount of claim 12, and further comprising a plate underlying the third layer.

16. The mount of claim 12, wherein the first, second, and third layers and the portion of the bracket have an opening therein.

17. The mount of claim 16, wherein the portion of the bracket is connected to a pair of flanges of the bracket.

18. (canceled)

19. The mount of claim 12, and further comprising a sleeve passing through the first, second, and third layers and the portion of the bracket.

20. The mount of claim 19, wherein the sleeve holds the first, second, and third layers and the portion of the bracket together.

21. A mount adapted to connect a vibration source to a support structure, comprising:
a bracket comprising a U-shaped portion having a cross member connected between a pair of legs, each of the pair of legs connected to a flange having mounting openings therein;
a first elastomeric layer having a first stiffness overlying the cross member;
a second elastomeric layer overlying the first elastomeric layer and having a second stiffness that is greater than the first stiffness, the second stiffness increases non-linearly with an increasing load applied thereto, the first and second elastomeric layers in contact along a single continuous plane;
a third elastomeric layer having the first stiffness and underlying the cross member so that the cross member is sandwiched between the first and third layers; and
a plate underlying the third elastomeric layer;
wherein the first, second, and third layers, the cross member, and the plate each have a connection opening therein, the respective connection openings aligned with each other.

22. A method of operation of a mount adapted to connect a vibration source to a support structure, comprising:
dissipating vibration energy from the vibration source using a first layer of the mount; and
absorbing shock load energy using a second layer of the mount that is in contact along a single continuous plane the first layer.

23. The method of claim 22, wherein dissipating vibration energy from the vibration source further comprises using a third layer of the mount, wherein the first and third layers sandwich a portion of a bracket of the mount therebetween.

24. The mount of claim 22, wherein the first layer is of neoprene and the second elastomeric layer is of polyurethane.

25-27. (canceled)

28. A method of connecting a vibration source to a support structure, comprising:
disposing first and second elastomeric layers between the vibration source and support structure so that the second layer is located between the first layer and the vibration source, wherein the first and second layers have different stiffnesses and are in contact with each other along a continuous single plane.

29. The method of claim 28, wherein the stiffness of the second elastomeric layer is greater than the stiffness of the first elastomeric layer.

30. (canceled)

31. The mount of claim 28, wherein the first elastomeric layer is of neoprene and the second elastomeric layer is of polyurethane.

32. A method of connecting a vibration source to a support structure, comprising:
forming a first elastomeric layer having a first stiffness on a portion of a bracket of a mount;
forming a second elastomeric layer on the first elastomeric layer, the second elastomeric layer having a second stiffness that is different than the first stiffness, the first and second elastomeric layers in contact with each other along a continuous single plane; and
connecting the mount between the vibration source and support structure so that the second elastomeric layer is immediately adjacent the vibration source.

33. The method of claim 32, and further comprising before connecting the mount between the vibration source and support structure, forming a third elastomeric layer underlying the portion of the bracket so that the first and third elastomeric layers sandwich the portion of the bracket therebetween.

34. The method of claim 33, wherein the third elastomeric layer has the same stiffness as the first elastomeric layer.

35. The method of claim 32, wherein the stiffness of the second elastomeric layer is greater than the stiffness of the first elastomeric layer.

36. (canceled)

37. The mount of claim 1, wherein the second stiffness of the second elastomeric layer increases non-linearly with an increasing load applied thereto.

38. The mount of claim 12, wherein the second stiffness of the second elastomeric layer increases non-linearly with an increasing load applied thereto.

39. The mount of claim 22, wherein a stiffness of the second layer increases non-linearly with the shock load.

40. The method of claim 28, wherein the stiffness of the second elastomeric layer increases non-linearly with an increasing load applied thereto.

41. The method of claim 32, wherein the stiffness of the second elastomeric layer increases non-linearly with an increasing load applied thereto.
